(19) United States
(12) Patent Application Publication
(10) Pub. No.: US 2007/0087232 A1
(43) Pub. Date: Apr. 19, 2007

(54) Capacitor hybrid fuel cell power generator

(76) Inventors: Curtis Michael Robin, Vancouver (CA); Sonja Elisabeth Macfarlane, Vancouver (CA); Iqbal Tony Manhas, Bumaby (CA)

Correspondence Address: GOWLING LAFLEUR HENDERSON LLP, P.O. BOX 49122, 2300-1055 DUNSMUIR ST., VANCOUVER, BC, V7X 1J1, CA

(21) Appl. No.: 11/476,083

(22) Filed: Jun. 28, 2006

Related U.S. Application Data
(63) Continuation-in-part of application No. 11/360,486, filed on Feb. 24, 2006.
Application No. 11/360,486 is a continuation-in-part of application No. 11/251,792, filed on Oct. 18, 2005.
(63) Continuation-in-part of application No. 11/436,594, filed on May 19, 2006.

(30) Foreign Application Priority Data
Oct. 18, 2005 (CA) 2,5232,640
Feb. 24, 2006 (CA) 2,537,728

(51) Int. Cl. H01M 8/04

(52) U.S. Cl. 429/13; 429/23

(57) ABSTRACT

An electrical power generator comprising at least one fuel cell and at least one capacitor electrically coupled together in parallel is operated in a manner that reduces stress on the fuel cell and prolongs fuel cell operating life. The operation comprises: monitoring a current drawn by a load; monitoring a voltage across the capacitor; and operating the fuel cell to generate an electrical output within a target output range when either the monitored current or voltage are within a respective selected current and voltage range, the fuel cell output supplying the load and/or recharging the capacitor. The capacitor is configured to discharge stored electrical energy to the load when the load exceeds the target output range.

### RELATED APPLICATION

This application is a continuation-in-part of U.S. application Ser. No. 11/360,486 “Fuel Cell Fluid Dissipater” to Robin et al., filed on Feb. 24, 2006: U.S. application Ser. No. 11/251,792 “Fluid Management System” to Mulvenna et al., filed on Oct. 18, 2005; and U.S. application Ser. No. 11/436,594 “Fuel Cell Power Pack” to Mulvenna et al., filed on May 18, 2006, which are all incorporated herein by reference in their entirety and for all teachings, disclosures and purposes.

### TECHNICAL FIELD

This invention relates to electrical power generation, and in particular to a power generator comprising a fuel cell and a capacitor.

### BACKGROUND OF THE INVENTION

Fuel cells generate electricity from an electrochemical reaction between a hydrogen-containing fuel and an oxidant. One type of fuel cell is a proton-exchange-membrane (PEM) fuel cell, which uses a proton conductive membrane such as NAFION® to separate the fuel and oxidant reactants. Other known fuel cells include solid oxide fuel cells (SOFC), alkaline fuel cells and direct methanol fuel cells (DMFC). Such fuel cells can be stacked together to provide a greater voltage, than can be generated by a single fuel cell.

Because fuel cells generate electricity electrochemically rather than by combustion, pollutants found in combustion products can be avoided, and fuel cells are perceived to be an environmentally friendlier alternative to combustion engines. Applications for fuel cells include stationary and portable power generators, and vehicular powerplants.

Especially in vehicular applications, the load on the fuel cell stack can vary dramatically over an operating cycle. Efforts have been made to develop efficient “load-following” fuel cell systems, which can quickly increase or decrease electrical output to match the load changes demanded by the application. However, load following tends to impose stresses on the fuel cell system, thereby increasing wear and tear on the fuel cell system components and decreasing system operating life.

One approach to reducing the stress on fuel cell systems used in variable load applications is to couple the fuel cell stack in parallel to an energy storage device, such as an electrochemical battery to produce a “hybrid” power system. In such an arrangement, the battery acts like a buffer for the fuel cell stack, supplying electricity in times of high demand, thereby reducing the peaks in electrical demand on the fuel cell system: when demand is low, the fuel cell stack can recharge the battery. Therefore, the load varations imposed on the fuel cell stack are smoothed and system operating life can be extended.

FIG. 1 illustrates an electrical schematic of a prior art hybrid fuel cell system 91 comprising a fuel cell stack 92, voltage conversion equipment 93, and a battery pack 94, all connected in parallel, and power distribution conductors 95, 96 to allow the parallel connection of a load. The fuel cell stack 92 is capable of generating electricity, provided that fuel and oxidant (collectively, “reactants”) are supplied, as is well known for fuel cell stacks. The voltage conversion equipment 93 is typically a DC/DC voltage converter that has a pulse width modulator as is well known for direct current voltage regulation. The fuel cell generator, voltage regulation equipment battery pack and load are coupled in parallel so that the both the fuel cell generator and the energy storage device can provide power to the load, and the fuel cell generator can provide energy to the energy storage device. The battery pack 94 has typically been provided to power peak load demands and to provide power to start the fuel cell generator 92.

There are challenges with implementing a battery hybrid fuel cell system as shown in FIG. 1. One of the most significant challenges is determining the state of charge of the battery. Typically, the battery's state is determined by measuring the current draw on the battery; however this approach does not provide a precise measurement of the banery's charge state, and therefore, it is difficult to precisely determine when and how much the battery needs to be charged by the fuel cell stack. Furthermore, electrochemical batteries do not have a particularly fast discharge rate, and thus sometimes may be not be able to meet the power demands by the load. Another disadvantage of using a battery in such a hybrid configuration is that the battery has a relatively slow recharge rate, and thus may not be able to be recharged quickly to supply power to rapidly variable loads.

There is thus a need to provide an effective fuel cell system that can supply power to highly variable loads in a way that does not unduly stress the fuel cell stack and reduce its operating life.

### SUMMARY OF THE INVENTION

According to one aspect of the invention, there is provided a method of operating an electrical power generator comprising at least one fuel cell and at least one capacitor electrically coupled together in parallel. The method comprises: monitoring a current drawn by a load; monitoring a voltage across the capacitor, and operating the fuel cell to generate an electrical output within a target output range when either the monitored current or voltage are within a respective selected current and voltage range, the fuel cell output supplying the load and/or recharging the capacitor. The capacitor is configured to discharge stored electrical energy to the load when the load exceeds the target output range. Operating the generator using such a method enables the fuel cell to operate within an efficient range that reduces stress on the fuel cell, thereby prolonging the life of the fuel cell.

The fuel cell output can be adjusted by adjusting the rate of oxidant transmitted to the fuel cell. The rate of transmitted oxidant is within a range that corresponds to the target output range of the fuel cell.

When the monitored current is below the current range and the monitored voltage is within the voltage range, the load is below the target output range of the fuel cell and the capacitor requires recharging. In such case, the recharging rate of the capacitor can be reduced by reducing the fuel cell output. This prolongs fuel cell power generation and reduces the frequency of starting and stopping the fuel cell, thereby reducing stress on the fuel cell.

Particularly, the fuel cell output can be reduced to a lower limit of the target output range to reduce the recharging rate of the capacitor to a minimum. When the monitored voltage reaches an upper limit of the voltage range, the fuel cell operation is stopped. The upper limit of the voltage range can be selected to correspond to a fully charged capacitor. Stopping fuel cell operation can comprise reducing the fuel cell output to zero as the monitored voltage approaches the upper limit of the voltage range. To further prolong fuel cell power generation, the fuel cell output rate is can be further reduced as the monitored voltage approaches the upper limit of the voltage range. Alternatively, stopping fuel cell operation can comprise directing the fuel cell output from recharging the capacitor to heating the fuel cell when the fuel cell output has not reached zero after the monitored voltage reaches the upper limit of the voltage range.

When the monitored current is above the current range, fuel cell output can be increased to an upper limit of the target output range.

Additionally, the temperature of the fuel cell can be monitored, and the fuel cell can be operated to generate an electrical output within the target output range when the monitored temperature falls below a selected setpoint. This operation keeps the fuel cell sufficiently warm so that the fuel cell can be quickly started. Starting the fuel cell to generate electrical output can comprise transmitting fuel and oxidant to the fuel cell using power supplied by the capacitor. Once the fuel cell is generating sufficient power, fuel and oxidant transmission can be powered by the fuel cell.

In accordance with another aspect of the invention, a computer readable memory is provided having recorded statements and instructions for execution by a programmable device to carry out the above method of operating an electrical power generator.

In accordance with another aspect of the invention, there is an electrical power generator comprising: at least one fuel cell; at least one capacitor electrically coupled to the fuel cell in parallel; a current sensor for monitoring a current drawn by a load; a voltage sensor for monitoring a voltage across the capacitor; and a controller communicative with the current sensor and voltage sensor, and programmed with the above method of operating the generator.

### BRIEF DESCRIPTION OF THE DRAWINGS

FIG. 1 is an electrical schematic of a prior art hybrid fuel cell power system.

FIG. 2 is a perspective view of a hybrid fuel cell power generator according to a first embodiment of the invention.

FIG. 3 is an electrical schematic of components in the power generator.

FIG. 4 is an electrical schematic of components of a controller assembly of the power generator.

FIG. 5 is an electrical schematic of a controller of the controller assembly communicative with components of the power generator.

FIG. 6 is a flow chart of a safety check procedure executed by the generator upon start up and during operation.

FIG. 7 is a flowchart of a system sensor check procedure 203 carried out by the generator.

FIG. 8 is a flowchart of a startup procedure carried out by the generator.

FIG. 9 is a flowchart of a run procedure carried out by the generator.

FIG. 10 is a flow chart of a shutdown procedure carried out by the generator.

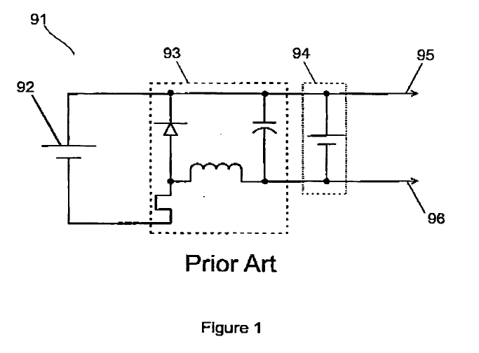

### DETAILED DESCRIPTION OF EMBODIMENTS OF THE INVENTION

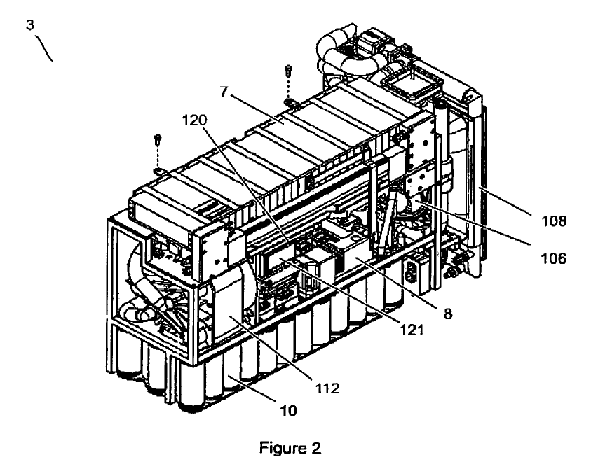

Referring to FIG. 2 and according to one embodiment of the invention, an electrical power generator 3 is provided which comprises a fuel cell stack 7 and a double-layer capacitor bank 10 electrically coupled in parallel. The fuel cell stack 7 electrochemically reacts gaseous hydrogen fuel supplied from a fuel tank (not shown) and oxygen from ambient air to produce electricity. By-products of the reaction include water and heat. The fuel cell stack 7 comprises a plurality of a proton exchange member (PEM) type fuel cells; a suitable such fuel cell stack is the Mark 902 stack manufactured by Ballard Power Systems. However, it is within the scope of the invention to use other fuel stacks as is known in the art. The capacitor bank 10 is made up of a plurality of double-layer capacitors connected in series to provide a capacitor voltage sufficient to meet the voltage requirements of a load, and each series-connect double-layer capacitor may consist of group of parallel connected double-layer capacitors so grouped to provide a current capacity sufficient to meet the current requirements of the load. The double-layer capacitor bank 10 is further provided with a voltage balancing circuit (not shown) connected in series between the series-connected capacitors, to ensure that the voltage of each series-connected capacitor is the same the voltage of the other series-connected capacitors. “Bootscap” brand capacitors made by Maxwell Technologies can be used for the capacitor bank 10. However, it is within the scope of the invention to use other suitable capacitors as is known in the art.

The generator 3 operates to supply load-following power from the capacitor bank 10 or the fuel cell stack 7, or both, as circumstances dictate. The generator 3 executes an operating strategy that operates the fuel cell stack 7 within parameters that reduces stress on the fuel cell stack 7, thereby increasing the stack's operating life. The operating strategy includes defining a stack operating range which minimizes the stress on the stack 7, then using the capacitor bank 10 to supplement the stack output by providing power when a load on the generator 3 exceeds the stack operating range. When the load drops to within or below the stack operating range, the operating strategy includes conducting some of the stack output to recharge the capacitor bank 10, and to shut down the stack 7 if necessary, i.e. when the load is below the stack operating range and the capacitor bank 10 is fully charged. Another aspect of the operating strategy is to reduce the frequency at which the stack 7 is started up and shut down, as such cycling tends to impose stress on the stack 7. Therefore, when the load falls below the stack operating range for an extended period of time, the generator 3 will reduce the recharging, rate of the capacitor bank 10 in order to extend the period of time that the stack remains on, i.e. continues to generate electricity. This strategy is particularly effective when the load is highly variable, and tends to reduce the frequency which the stack 7 starts up and shuts down.

The generator 3 also includes “balance of plant components 16 for controlling the supply of oxidant and fuel to the fuel cell stack, controlling and conditioning the supply of electricity generated by the stack 7, cooling and humidifying the stack 7, and removing excess water, unreacted fuel and air and contaminants from the stack 7. Such balance of plant components 16 include at least a cooling system fan 106, a radiator 108, and an air compressor 112.

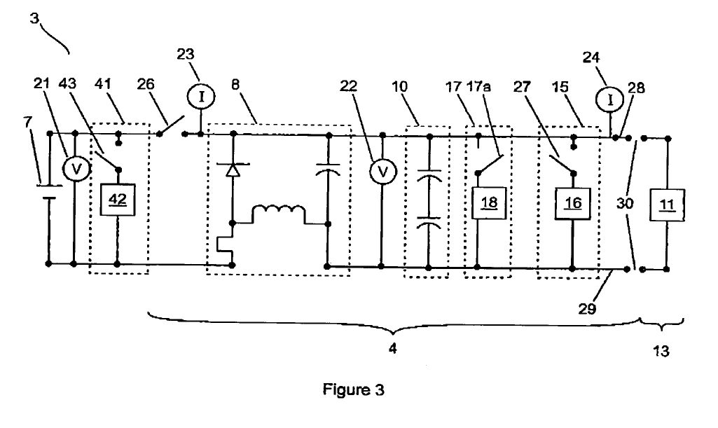

Referring to FIG. 3, the fuel cell stack 7 and capacitor bank 10 are electrically coupled in parallel to a power circuit 4, which in turn can be electrically coupled to a variable load 11 by a load circuit 13. The power circuit 4 comprises positive and negative conductors 28, 29 that conduct electricity generated by me stack 7 to the load 11. A voltage converter 8 is located on the power circuit 4 between the stack 7 and the capacitor bank 10 and serves to convert the voltage of electricity generated by the stack 7 to a voltage required by the load 11. The voltage converter 8 includes a pulse width modulator for modulating an input voltage to an output voltage, as is well known in the art.

A first contactor 26 is provided on the positive conductor 28 between the stack 7 and the voltage converter 8 and serves to electrically couple and uncouple the stack 7 from the power circuit 4. A stack voltage sensor 21 is connected to the power circuit 4 between the stack 7 and the first contactor 26 and measures stack voltage. A stack current sensor 23 is connected to the positive conductor 28 between the first contactor 26 and voltage converter 8 and measures stack current.

The balance of plant components 16 are electrically coupled to the power circuit 4 by a component circuit 15 which is located on the power circuit 4 between the capacitor bank 10 and the load 11. A second contactor 27 is provided on the component circuit 15 to couple or uncouple the balance of plant components 16 from the power circuit 4. A controller assembly 18 for controlling operation of the capacitor hybrid fuel cell generator 3 is electrically coupled to the power circuit 4 by a controller circuit 17, which is located on the power circuit 4 between the capacitor bank 10 and the component circuit 15. A key switch contactor 17a is provided on the controller circuit 17 to couple or uncouple the controller assembly 18 from the power circuit 4. So configured, the balance of plant components 16 and the controller assembly 18 can be powered by electricity supplied by the ultra capacitor bank 10.

A power circuit switch 30 is provided on the positive conductor 28 between the component circuit 15 and the load 11 to couple and uncouple the power circuit from the load 11.

A capacitor voltage sensor 22 is positioned across the capacitor bank 10 to measure the voltage of the power circuit 4 at the capacitor bank 10. A power circuit current sensor 24 is positioned at the positive conductor 28 to measure the current of the power circuit 4, and when the contactor 26 is opened, the current of the capacitor bank 10.

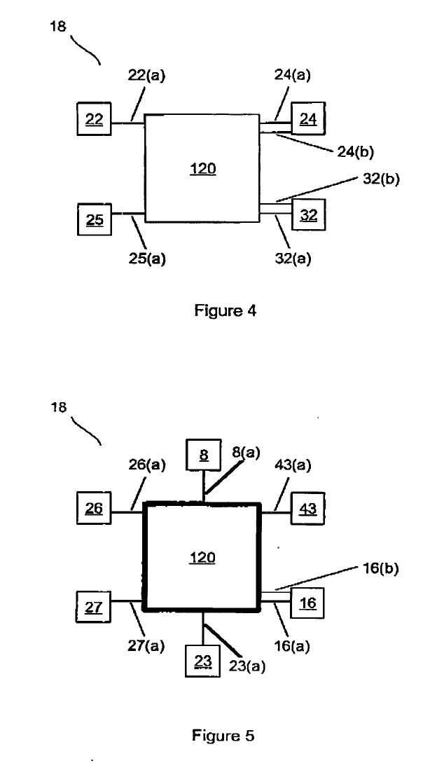

A heater circuit 41 is provided to heat the coolant of the cooling system, and thereby heat the stack 7. The heater circuit 41 is in parallel with the fuel cell stack 7 between the stack 7 and the first contactor 26. The heating circuit includes at least one heater component 42 and a coolant temperature sensor 25 (shown in FIG. 4) configured to sense the temperature of the coolant of the cooling system. The heater component is preferably a resistor installed within a cooling circuit of the fuel cell stack 7, and positioned within the cooling circuit to heat the coolant near the coolant inlet to the fuel cell stack 7. Alternatively, the heater component 42 may be a resistor in a water passage in a humidifier or fluid management system in close association with the fuel cell stack, or it may be a hot air blower positioned to blow hot air onto the fuel cell stack, or it may be another type of heating apparatus installed to provide heat to the fuel cell stack. A third contactor 43 is provided to allow the heater circuit 41 to be isolated from the fuel cell stack 7. The third contactor 43 is electrically activated, and is under the control of the controller assembly 18.

Referring to FIG. 4, the controller assembly 18 includes a controller 120, a hydrogen gas leak sensor 32, and communication means to the capacitor voltage sensor 22, the power circuit current sensor 24 and the coolant temperature sensor 25. The controller 120 receives voltage data from the capacitor voltage sensor 22 via data line 22(a), and receives temperature data from the coolant temperature sensor 25 via data line 25(a). The controller 120 provides power to power circuit current sensor 24 by power supply line 24(b) and receives current data from same via data line 24(a). The controller 120 provides power to the hydrogen gas leak sensor 32 by power supply line 32(b) to provide power to the leak sensor, and communicates with same via data line 32(a).

Referring to FIG. 5, the controller 120 receives voltage data from the stack voltage sensor 23 via data line 23(a). The controller 120 sends control signals to the first contactor 26 by control line 26(a), to the second contactor 27 by control line 27(a), to a fourth contactor 43 by control line 43(a), and to the voltage converter 8 by control line 8(a). The controller 120 also sends control signals to the balance of plant components 16 by control line 16(a), and receives data from balance of plant components by data line 16b.

The capacitor hybrid fuel cell generator 3 can include a key switch (not shown) that opens and closes a key switch contactor 17a. The key switch contactor 17a is closed when the key switch is set to an “On” position, and is open when the key switch is set to an “Off” position. The generator 3 is ready to operate as long as fuel is available to the fuel cells, and the key switch contactor 17a is closed. When ready to operate, the generator 3 can start up the fuel cell stack 7 as required, and as described in detail below under the heading “start up procedure”.

Operating Strategy

The controller 120 is programmed with a target output range to correspond with the most efficient operating output range of the stack 7. The controller 120 effects operation of the stack 7 within the stack's target output range through operational control of balance of plant components 16 and through operational control of the voltage converter 8. Feedback on the operational state of the generator 3, including data on the target output range reaches the controller 120 by way of data from the system sensors 22, 24, and the stack current sensor 23. In alternate embodiments of the present invention, direct feedback from the balance of plant components 16 and/or from the voltage converter 8 may be used instead of or in addition to data from the system sensors.

Operating the stack 7 to generate a generally steady state output within the target output range ensures that stresses on the stack 7 are minimized, thereby increasing the operating life of the stack 7. However, it is within the scope of the invention for the target output range to be based on other parameters as desired by the operator.

The controller 120 instructs the stack 7 to generate a power output to supply the load 11 and/or to charge the capacitor bank 10 up to a maximum output corresponding to the upper limit of the target output range. When the load 11 is above the target output range of the stack 7, additional electricity is discharged by the capacitor bank 10 to meet the load 11. When the load 11 is within the target output range, some of the electricity generated by the stack 7 can be used to recharge the capacitor bank 10 if recharging is required. In this way, the capacitor bank 10 functions as an energy storage device, at times storing energy, and at times supplying energy.

When the load 11 continues to be more than the target output range of stack 7, the controller 120 instructs the balance of plant components 16 to increase the air flow to the stack 7 to increase the level of power generated up to the upper limit of the target output range, and the controller 120 instructs the voltage converter 8 to ramp up accordingly.

When the load 11 falls below the target output range of the stack 7 and the capacitor bank 10 requires recharging, the controller 120 reduces the stack output to the lower limit of the stack output range, and the stack output not needed to supply the load is used to recharge the capacitor bank 10. This procedure is defined as a “first ramp down phase”, and involves the controller signalling the balance of plant components 16 to ramp down the air flow at a first rampdown rate to a level corresponding to the minimum level of the target output range of the stack 7, and the controller 120 signals the voltage converter 8 to ramp down accordingly.

When the capacitor bank 10 is recharged past a certain threshold represented by a capacitor voltage setpoint, a second rampdown phase is initiated wherein a second rampdown rate is effected that is lower than the first rampdown rate. That is, the controller 120 signals the balance of plant components 16 to ramp down power generation at the second rampdown rate. This slows down the recharge rate of the capacitor bank 10, thereby allowing the fuel cell stack 7 to continuing operating, and reducing the frequency at which the stack 7 has to shut down and start up. Such repeated shut downs and start ups increase the stress on the fuel cell stack 7 and reduces the stack's operating life.

Shutdown Strategy

When the voltage of the capacitor bank 10 nears full capacity, i.e. the capacitors are nearly fully charged, the controller 120 signals the balance of plant components 16 to stop the air flow to the stack 7, thereby completing the shut down of the stack 7.

Shutting down of the stack 7 does not immediately terminate power generation in the stack 7, as is well known for fuel cell generators. A stack bleed down procedure has typically been applied to absorb the residual power so generated. Residual oxidant reacts with residual fuel or recirculating fuel to generate power. A power sink or energy storage device can be advantageously applied to absorb the generated power, as can a resistor to convert the power into heat.

In the present embodiment, the stack 7 is shut down before the capacitors are fully charged. In this way, the capacitors retain some energy storage capability when the stack 7 is shut down, and absorb the residual power. When the capacitor bank 10 is fully charged, the controller 120 opens the first contactor 26 to prevent overcharging of the capacitors, and closes the fourth contactor 43 to divert the remaining residual power to the heater component 42.

Safety Check Procedure

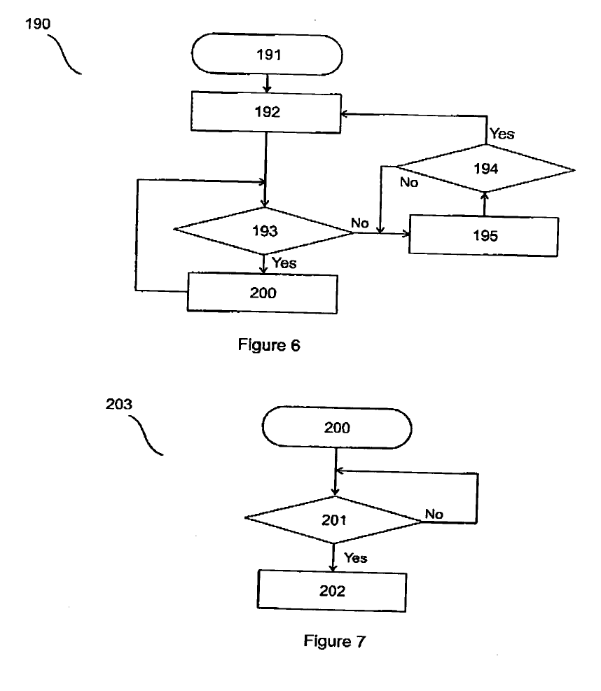

FIG. 6 illustrates a safety check procedure 190 executed by the generator 3 upon closing the key switch contactor 17a and continually during system operation. The key switch contactor 17a is open in start block 191. When the key switch contactor 17a is closed (step 192), the controller assembly 16 receives power from the controller circuit 17, and the controller 120 and hydrogen gas leak sensor 32 become powered. Once powered, the controller 120 monitors the hydrogen gas leak sensor 32. The hydrogen gas leak sensor 32 measures concentration of hydrogen gas in air inside the stack 7 (step 193) and sends hydrogen concentration data to the controller 120. When the hydrogen concentration is above a first safety setpoint, the controller 120 opens the key switch contactor 17a to prevent the stack 7 from generating power (step 195) thereby preventing a possible explosion in the stack 7 caused by an inadvertent ignition of the hydrogen in air. This first safety setpoint is assigned as a percentage of the lower flammability limit (LFL) of hydrogen in air. The key switch contactor 17a remains open until it is reset by an operator (step 194). Upon reset, the key switch contactor 17a closes and the safety check procedure returns to step 192. When the detected hydrogen concentration in the air is less than the first safety setpoint, the generator 3 enters a ready state 200, and the controller 120 continually monitors the hydrogen gas leak sensor 32 until either the key switch contactor 17a is opened, or a detected hydrogen concentration exceeds the first safety setpoint.

In an alternate embodiment, the generator 3 does not have a key switch contactor 17a, and is always in the ready slate.

Demand Check Procedure

Once the generator 3 is in the ready state 200, the controller 120 is programmed to check for power demand, and when a power demand is sensed, to initiate a startup procedure in a demand check procedure 203, the controller 120 monitors the system sensor 22, 24, 25 for current, voltage and temperature date respectively, and starts the stack 7 when the current, voltage or temperature conditions require that power be added to the generator 3.

Power is demanded from the stack 7 when the load 11 exceeds a certain current level; when the capacitor bank 10 needs recharging indicated by a certain voltage level; or when the temperature of the slack 7 drops below a certain temperature level. The levels at which the current, voltage or temperature conditions trigger startup of the stack 7 are programmed as setpoints in the controller 120.

Referring to FIG. 7 there is illustrated the demand check procedure 203 carried out by the controller 120 to determine whether the stack 7 needs to be started for power generation. When the generator 3 is in the ready state 200, the controller 120 monitors the system sensors 22, 24, 25, as represented by decision block 201. When any of the system sensors report a value beyond their respective setpoints, the controller 120 initiates startup of the fuel cell stack 7, as represented by block 202. As long as none of the system sensors 22, 24, 25 detect a value beyond their respective setpoints, and the key switch contactor 17a is closed, the controller 120 keeps monitoring the system sensors.

When the generator 3 is in ready state 200, the heater circuit 41 is not normally active; however, when the controller receives a temperature signal from the coolant temperature sensor 25 that is below a low temperature setpoint, the controller starts up the fuel cell stack 7 and closes the fourth contactor 43, and the first contactor 26. In this way the generated energy from the fuel cell stack 7 is provided to the heater circuit 41 to heat the coolant and thereby the fuel cell stack 7. When the coolant temperature sensor 24 reports a continued coolant temperature at a second temperature setpoint that is higher than the first temperature setpoint, the controller shuts down the stack 7 by initiating a shutdown procedure, described in detail under the heading ‘shutdown procedure’. Typically, running the stack 7 for 30 seconds is sufficient to heat the stack 7 to the second temperature setpoint in this way, the generator 3 prevents the fuel cell stack 7 from freezing.

For a generator 3 intended for use in environments where the ambient temperature never approaches freezing, the heating circuit 41 and the heater components 41 may be removed or bypassed.

Startup Procedure

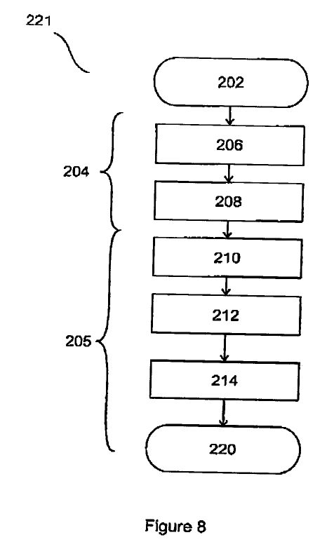

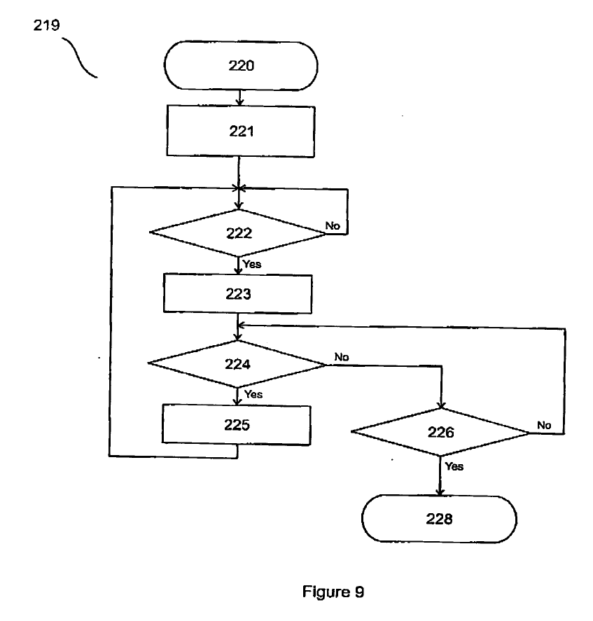

Referring to FIG. 8 there is illustrated a startup procedure 221 carried out by the controller 120. The startup procedure 221 is designed to efficiently start up power generation in the fuel cell stack 7. Power for the balance of plant components 16 during the startup procedure is provided by the capacitor bank 10. The startup procedure 221 may be divided into a first phase 204, and a second phase 205. Generally speaking, in the first phase 204 the controller 120 closes the second contactor 27 in order to deliver power to the balance of plant components 16: and in the second phase 205 the controller 120 initiates the flow of reactants to the fuel cell stack 7.

Specifically, in the first phase 204 the controller actions are represented by process block 206 in which the Controller 120 closes the second contactor 27 to close the component circuit 15 thereby supplying power to balance of plant components 16. The startup procedure continues as represented by process block 208 in which the controller 120 signals an air compressor relay (not shown) to close, thereby readying the air compressor 112 for operation.

In the second phase 205, the controller actions are represented by process block 210 in which the controller 120 activates a fuel circulation pump (not shown) and related components to deliver fuel to the stack 7, and by process block 212, in which the controller activates the air compressor 112 to supply oxidant in air to the stack 7; and by process block 214 in which the controller 120 activates a coolant pump (not shown) to supply coolant to the stack 7.

When the actions represented by process block 214 are complete, the startup procedure 221 is complete, as represented by block 220. The startup procedure 221 takes 3 to 5 seconds to complete. Contactor 26 is closed, and the stack 7 enters into a run state wherein electricity is generated.

Run Check Procedure

Referring to FIG. 9 there is illustrated in a flow chart of a run check procedure 219 that illustrates how the controller 120 determines whether to keep the stack 7 operating or shut down the stack operation.

When the generator 3 is in the run state 220, the controller 120 is operative to adjust the operation of the balance of plant components 16 and the operation of the voltage converter 8.

Blocks 222 through 225 represent a run check sub-procedure that the controller 120 continually applies to determine whether power generation is required or not. When power generation is not required for a selected length of time, the run procedure 219 ends, and the shutdown procedure as represented by block 228 starts.

In detail, as represented by decision block 222, the controller 120 monitors the power circuit current sensor 24 to ascertain whether the current draw has dropped below a first current setpoint as stored in controller memory; and the controller 120 monitors the capacitor bank voltage sensor 22 to ascertain whether the capacitor voltage has risen above a first voltage setpoint as stored in controller memory. When not, power generation continues and the controller continues to monitor the sensors.

When both the first current setpoint and the first voltage setpoint are surpassed, the controller 120 starts an internal timer, as represented by process block 223, and then as represented by decision block 224, the controller monitors the power circuit current sensor 24 to ascertain whether the current draw has risen above a second current setpoint; and monitors the capacitor bank voltage sensor 22 to ascertain whether the capacitor voltage has dropped below a second voltage setpoint. When either second setpoint is surpassed, power generation continues, and the controller resets the internal timer as represented by process block 225. The controller continues to monitor the system sensors 22, 24 as represented by decision block 222.

In this way, when the load 11 returns to within the target output range of the stack 7 or when the capacitor bank 10 needs recharging, power generation by the stack continues.

When neither the current nor the voltage reach their respective first setpoints, the controller refers to the internal timer to check whether the setpoint has been surpassed by a length of time, as represented by decision block 226, and when that length of time has not been surpassed, the controller continues to monitor the system sensors 22, 24 as represented by decision block 224. When that length of time has been surpassed, the controller 120 initiates the shutdown procedure as represented by block 228.

Shutdown Procedure

The shutdown procedure 230 is initiated when the voltage of the capacitor bank 10 rises above a shutdown voltage setpoint, and the current drops below a shutdown current setpoint. When these two conditions occur, the controller 120 shuts down the fuel cell stack 7, and bleeds down residual generated power. In this way, the shutdown procedure 230 returns the generator 3 to the ready state 200.

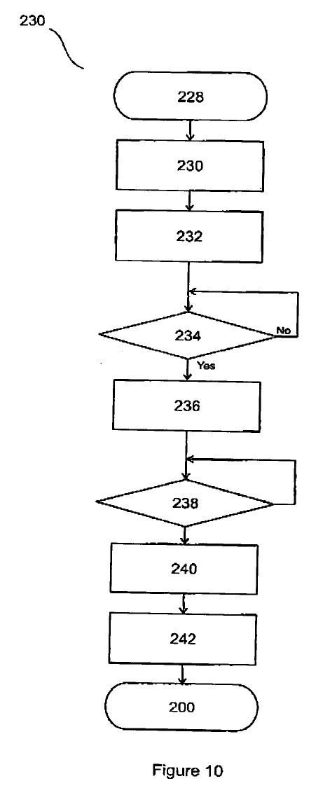

Referring to FIG. 10 there is illustrated in a flow chart of the shutdown procedure 230 that illustrates how the controller 120 shuts down the stack 7 and bleeds down the residual generated power.

When the capacitor hybrid fuel cell generator 3 is in the shutdown state 228, the controller 120 is operative to shut down the operation of the balance of plant components 16 and the operation of the voltage converter 8. As represented by process block 230, the controller signals the balance of plant components 16 to terminate air flow to the stack 7 to end power generation. As represented by process block 232 the residual generated power is conducted to the capacitor bank 10. In decision block 234, the controller 120 monitors the stack voltage sensor 21 and when the sensed voltage is less than the voltage of a fully charged capacitor, the controller does nothing to allow the residual power to continue conducting to the capacitor bank 10. When the sensed voltage is equal to the voltage of a fully charged capacitor, the controller 120 opens the first contactor 26, and closes the fourth contactor 43, as represented by process block 236. In this way, the residual generated power is diverted from the capacitor bank 10 to the heater circuit 41 where it is converted to heat within the coolant of the generator's cooling system. As represented by decision block 238, the controller continually monitors the stack current sensor 23 to determine when the residual power generation has ended. When residual power generation has ended, the controller 120 opens the fourth contactor 43 to disconnect the heater circuit 41 from the stack 7 and the controller shuts down the fuel circulation pump (not shown) to save energy, as represented by process block 240. Next, as represented by process block 242, the controller 120 opens the second contactor 27 to unpower the balance of plant components 16. On completion of this shutdown procedure 230, the generator 3 returns to the ready state 200.

In an altercate embodiment, the power circuit current sensor 24 is eliminated, and only the capacitor bank voltage sensor 22 is used to provide information to the controller 120 to determine whether to start or increase power generation of the fuel cell stack 7. In this embodiment, a current value can still be used to provide for efficient start up of the fuel cell stack 7 by calculating the power circuit current from the capacitor voltage using the formula:
I=dVc/dt×F
Where:

I is the current in Amps

d denotes ‘delta’

Vc is the voltage across the double-layer capacitors in Volts

t is time

F is the capacitance of the double layer capacitor(s) in Farads

In another alternative embodiment, the preferred voltage in process block 226 is substantially reduced when the controller 120 senses a low fuel signal from a pressure transducer (not shown) on a fuel supply to the fuel cell stack 7. In this way, shutdown is initiated at a lower voltage level than normal; and equipment powered by the capacitor hybrid fuel cell generator 3 and coupled to receive a voltage value from the controller 120, receives a voltage value equivalent to a trigger voltage for an interrupt device, such as a lift interrupt on a lift truck, and therefore activates the interrupt device. When such equipment is provided with a voltage gauge, as is often incorporated to show the equipment operator that a battery installed to power the equipment requires charging, the received lowered voltage value from the generator 3 informs the operator that the fuel supply for the generator 3 requires fuel. An additional benefit of providing a lowered voltage to such equipment is that the equipment operates sluggishly, thereby simulating the sluggish operation associated with a battery that requires charging. The preferred voltage reduction is 6.3 Volts for a nominal 36-Volt power system to mimic the voltage drop of a 36-Volt battery system that requires charging of the battery.

In yet another alternative embodiment, the capacitor hybrid fuel cell generator 3 can further reduce the adverse effects of load following by the controller inputting the voltage value of the double-layer capacitor bank 10 and filtering the voltage value to eliminate outlier values and otherwise smooth and average the voltage values inputted over a time period, the time period preferably being 5 seconds, however another time period may be used without detracting from the invention in the preferred embodiment of the invention, the controller continually samples the voltage of the capacitor bank voltage sensor 22 in 20, 20 and 10 millisecond (ms) intervals, filters the voltages values received, and outputs a control signal to the fuel cell stack 7 and the voltage converter 8 every 50 ms, however, another sampling rate and/or control signal rate may be used without detracting from the invention. In this way, the lifetime of the fuel cells, and therefore the lifetime of the capacitor hybrid fuel cell generator 3, is improved, and due to the high cost of fuel cells, the cost of the capacitor hybrid fuel cell generator 3 over time is reduced.

It is to be understood that even though various embodiments and advantages of the present invention have been set forth in the foregoing description, the above disclosure is illustrative only, and changes may be made in detail, and yet remain within the broad principles of the invention. Therefore, the present invention is to be limited only by the claims appended to the patent.

We claim:

1. A method of operating an electrical power generator comprising at least one fuel cell and at least one capacitor electrically coupled together in parallel, the method comprising:
(a) monitoring a current drawn by a load;
(b) monitoring a voltage across the capacitor; and
(c) operating the fuel cell to generate an electrical output within a target output range when either the monitored current or voltage are within a respective selected current and voltage range, the fuel cell output supplying the load and/or recharging the capacitor;
wherein the capacitor is configured to discharge stored electrical energy to the load when the load exceeds the target output range.

2. A method as claimed in claim 1 further comprising adjusting the fuel cell output by adjusting the rate of oxidant transmitted to the fuel cell.

3. A method as claimed in claim 2 wherein the rate of transmitted oxidant is within a range that corresponds to the target output range of the fuel cell.

4. A method as claimed in claim 1 further comprising when the monitored current is below and the monitored voltage is within the respective current and voltage ranges, reducing the recharging rate of the capacitor by reducing the fuel cell output.

5. A method as claimed in claim 4 further comprising reducing the fuel cell output to a lower limit of the target output range to reduce the recharging rate of the capacitor to a minimum, then stopping fuel cell operation when the monitored voltage reaches an upper limit of the voltage range.

6. A method as claimed in claim 5 wherein stopping fuel cell operation comprises reducing the fuel cell output to zero as the monitored voltage approaches the upper limit of the voltage range.

7. A method as claimed in claim 6 wherein during stopping fuel cell operation, the fuel cell output rate is reduced when the monitored voltage reaches a selected voltage setpoint.

8. A method as claimed in claim 5 wherein stopping fuel cell operation comprises directing the fuel cell output from recharging the capacitor to heating the fuel cell when the fuel cell output has not reached zero after the monitored voltage reaches the upper limit of the voltage range.

9. A method as claimed in claim 6 wherein an upper limit of the voltage range is selected to correspond to a fully charged capacitor.

10. A method as claimed in claim 1 further comprising when the monitored current is above the current range, increasing the fuel cell output to an upper limit of the target output range.

11. A method as claimed in claim 1 further comprising monitoring a temperature of the fuel cell, and operating the fuel cell to generate the electrical output within the target output range when the monitored temperature falls below a selected setpoint.

12. A method as claimed in claim 1 wherein operating the fuel cell to generate the electrical output comprises transmitting fuel and oxidant to the fuel cell using power supplied by the capacitor.

13. A computer readable memory having recorded statements and instructions for execution by a programmable device to carry out a method of operating an electrical power generator comprising at least one fuel cell and at least one capacitor electrically coupled together in parallel, the method comprising
(a) monitoring a current drawn by a load;
(b) monitoring a voltage across the capacitor; and
(c) operating the fuel cell to generate an electrical output within a target output range when either the monitored current or voltage are within a respective selected current and voltage range, the fuel cell output supplying the load and/or recharging the capacitor;
wherein the capacitor is configured to discharge stored electrical energy to the load when the load exceeds the target output range.

14. A memory as claimed in claim 13 wherein the method further comprises adjusting the fuel cell output by adjusting the rate of oxidant transmitted to the fuel cell.

15. A memory as claimed in claim 14 wherein the rate of transmitted oxidant is within a range that corresponds to the target output range of the fuel cell.

16. A memory as claimed in claim 13 wherein the method further comprises when the monitored current is below and the monitored voltage is within the respective current and voltage ranges, reducing the recharging rate of the capacitor by reducing the fuel cell output.

17. A memory as claimed in claim 16 wherein the method further comprises reducing the fuel cell output to a lower limit of the target output range to reduce the recharging rate of the capacitor to a minimum, then stopping fuel cell operation when the monitored voltage reaches an upper limit of the voltage range.

18. A memory as claimed in claim 17 wherein stopping fuel cell operation comprises reducing the fuel cell output to zero as the monitored voltage approaches the upper limit of the voltage range.

19. A memory as claimed in claim 18 wherein during stopping fuel cell operation, the fuel cell output rate is reduced when the monitored voltage reaches a selected voltage setpoint.

20. A memory as claimed in claim 17 wherein stopping fuel cell operation comprises directing the fuel cell output from recharging the capacitor to heating the fuel cell when the fuel cell output has not reached zero after the monitored voltage reaches the upper limit of the voltage range.

21. A memory as claimed in claim 17 wherein the upper limit of the voltage range is selected to correspond to a fully charged capacitor.

22. A memory as claimed in claim 13 wherein the method further comprises when the monitored current is above the current range, increasing the fuel cell output to an upper limit of the target output range.

23. A memory as claimed in claim 13 wherein the method further comprises monitoring a temperature of the fuel cell, and operating the fuel cell to generate the electrical output within the target output range when the monitored temperature falls below a selected setpoint.

24. A memory as claimed in claim 13 wherein operating the fuel cell to generate the electrical output comprises transmitting fuel and oxidant to the fuel cell using power supplied by the capacitor.

25. An electrical power generator comprising
(a) at least one fuel cell;
(b) at least one capacitor electrically coupled to the fuel cell in parallel;
(c) a current sensor for monitoring a current drawn by a load;
(d) a voltage sensor for monitoring a voltage across the capacitor; and
(e) a controller communicative with the current sensor and voltage sensor, and programmed with a method of operating the generator comprising
(i) monitoring the current sensor;
(ii) monitoring the voltage sensor; and
(iii) operating the fuel cell to generate an electrical output within a target output range when either the monitored current or voltage are within a respective selected current and voltage range, the fuel cell output supplying the load and/or recharging the capacitor;
wherein the capacitor is configured to discharge stored electrical energy to the load when the load exceeds the target output range.

26. A generator as claimed in claim 25 further comprising an air compressor and wherein the controller is further programmed to adjust the fuel cell output by adjusting the rate of oxidant transmitted to the fuel cell by the air compressor.

27. A generator as claimed in claim 26 wherein the rate of transmitted oxidant is within a range that corresponds to the target output range of the fuel cell.

28. A generator as claimed in claim 25 wherein the method programmed on the controller further comprises when the monitored current is below and the monitored voltage is within the respective current and voltage ranges, reducing the recharging rate of the capacitor by reducing the fuel cell output.

29. A generator as claimed in claim 28 wherein the method programmed on the controller further comprises reducing the fuel cell output to a lower limit of the target output range to reduce the recharging rate of the capacitor to a minimum, then slopping fuel cell operation when the monitored voltage reaches an upper limit of the voltage range.

30. A generator as claimed in claim 29 wherein stopping fuel cell operation comprises reducing the fuel cell output to zero as the monitored voltage approaches the upper limit of the voltage range.

31. A generator as claimed in claim 30 wherein during stopping fuel cell operation, the fuel cell output rate is reduced when the monitored voltage reaches a selected voltage setpoint.

32. A generator as claimed in claim 29 wherein stopping fuel cell operation comprises directing the fuel cell output from recharging the capacitor to heating the fuel cell when the fuel cell output has not reached zero after the monitored voltage reaches the upper limit of the voltage range.

33. A generator as claimed in claim 29 wherein the method programmed on the controller further comprises selecting an upper limit of the voltage range to correspond to a fully charged capacitor.

34. A generator as claimed in claim 25 wherein the method programmed on the controller further comprises when the monitored current is above the current range, increasing the fuel cell output to an upper limit of the target output range and transmitting power stored in the capacitor to the load.

35. A generator as claimed in claim 25 wherein the load is an operation of an electric vehicle, and the generator is configured to fit within a battery bay of the vehicle.

36. A generator as claimed in claim 25 further comprising a temperature sensor for monitoring a temperature of the fuel cell, and the method programmed on the controller further comprises operating the fuel cell to generate the electrical output within the target output range when the monitored temperature falls below a selected setpoint.

37. A generator as claimed in claim 25 wherein operating the fuel cell to generate the electrical output comprises transmitting fuel and oxidant to the fuel cell using power supplied by the capacitor.
